(19) United States
(12) Patent Application Publication
(10) Pub. No.: US 2016/0123884 A1
(43) Pub. Date: May 5, 2016

(54) FLUORESCENCE DETECTION DEVICE, SYSTEM AND PROCESS

(71) Applicant: CIRTEMO, LLD, Cayce, SC (US)

(72) Inventor: Ryan J. PRIORE, Wexford, PA (US)

(21) Appl. No.: 14/897,726

(22) PCT Filed: Jun. 11, 2014
(86) PCT No.: PCT/US2014/041909

§ 371 Date: Dec. 11, 2015

Related U.S. Application Data
(60) Provisional application No. 61/833,881, filed on Jun. 11, 2013.

(51) Int. Cl. G01N 21/64

(52) U.S. Cl. CPC G01N 21/6428; G01N 21/645; G01N 2021/6439; G01N 2021/6471

(57) ABSTRACT

An optical fluorescence analysis system (100), optical device, and optical analysis process are disclosed. The optical analysis system includes one or more optical filter mechanisms (110) disposed to receive and/or modulate light from a light source (108) and a detector mechanism (112) configured for operative communication with the one or more optical filter mechanisms, the operative communication permitting measurement of properties of filtered light, filtered by the one or more optical filter mechanisms from the light received and/or modulated. The one or more optical filter mechanisms are configured so that the magnitude of the properties measured by the detector mechanism is proportional to information carried by the filtered light.

### PRIORITY

The present application is an international Patent Cooperation Treaty patent application claiming priority and benefit to U.S. provisional patent application No. 61/833,881, filed Jun. 11, 2013, the entirety of which is hereby incorporated by reference.

### FIELD OF THE INVENTION

The present disclosure is in the technical field of spectroscopy. More particularly, the disclosure relates to spectral variance compressive detection systems, devices, and processes.

### BACKGROUND

Chemical analysis usually consists of two processes: calibration and prediction. Calibration is the process of defining a mathematical model to relate an instrumental response or responses to a chemical or physical property of a sample. An instrument may yield one, two or multiple responses which are termed as variables. One output variable is referred to as a univariate measurement whereas multiple output variables are referred to as a multivariate measurement. Prediction is the act of using a calibration model based on a known chemical or physical property of a sample and predicting the properties of future samples from the instrumental output response variables.

Life science assays such as flow cytometry, tissue staining, polymerase chain reaction (PCR), and enzyme-linked immunosorbent assays (ELISA) can use fluorescent tagging or labeling techniques with fluorochromes, dyes, or quantum dots as the mechanism for analyte detection or discrimination. Commercially available antibodies directly conjugated to highly purified fluorochromes can offer a wide variety of target specificities and color options, with the success of a multi-parameter fluorescent assay fundamentally dependent on the selection of fluorescent labels.

The optical subsystem for detecting the fluorescent labels can be basically a filter photometer in which an excitation light source-laser or light-emitting diode (LED)-induces fluorescence of the taggant molecules at the sample. Fluorescence signals can be collected by relay optics, passed through optical band-pass filters, and ultimately detected by a photodiode or photomultiplier tube.

To measure multiple taggants (fluorescence colors) simultaneously, an optimization of light source and emission optical band-pass filter(s) can be performed, where the band-pass filter for each fluorescent target captures a high level of emitted photons at the primary detector for the target while minimizing the contribution of overlapping emission into the secondary or “spillover” detectors. Unfortunately, this spectral overlap can present problems when using a filter-based analysis system.

To detect a target fluorescent target in the presence of significant spectroscopic overlapping fluorescent noise sources, compensation (multi-parameter correction based on linear algebra) can be needed via hardware and software for traditional optical band-pass filters. Compensation can be achieved through the use of traceable standards. Analytical measurements can be performed on the standards to assess the total impact of spectroscopic overlap. For multicolor or multi-parameter flow cytometry, compensation is not always a trivial process and unfortunately can lead to standard deviation differences in measured signals among the primary and spillover detectors (resulting in broader detection distributions and decreased sensitivities) as well as fluorescence detections less than zero.

Full spectroscopic (or multi-wavelength) detection as opposed to discrete band-pass detection can increase the specificity and sensitivity for a fluorescent target; however, the introduction of a spectrometer is not always feasible based upon the system requirements of life science assays. Existing detection methods do not possess the sensitivity and specificity of a laboratory optical spectrometer with the simplicity and form factor of a filter photometer instrument configuration.

Linear, multivariate models of complex data sets like fluorescence emission spectra may be developed through the transformation of the measured variables or spectral data onto orthogonal basis vectors via Principal Component Analysis (PCA). These basis vectors, also known as Principal Components (PC) model statistically significant variation in the data as well as measurement noise. The data dimensionality is ultimately reduced to a set of basis vectors that model only spectral and measurement variation which spans the space of the data matrix without prior knowledge of the chemical components.

A popular method of calculating the PCs of a data matrix is through the Singular Value Decomposition (SVD) algorithm. A data matrix like absorbance measurements may be decomposed into three new matrices:

X=USV^{T} (Equation 1)

where the columns of U contain the column-mode eigenvectors or PC scores of X, the diagonal of S contains the square root of the eigenvalues of X^{T}X, and the rows of V^{T} contain the row-mode eigenvectors or PC loadings of X. The first eigenvector of V^{T} corresponds to the largest source of variation in the data set, while each additional eigenvector corresponds to a smaller source of variation in the data. The scores or projections of the original absorbance vectors in the PC space are computed by multiplying the U matrix by the S matrix. FIG. 1 illustrates the data matrix relationship in SVD.

Because the PCs are orthogonal, they may be used in a straight forward mathematical procedure to decompose a light sample into the component magnitudes which accurately describe the data in the original sample. Since the original light sample may also be considered a vector in the multi-dimensional wavelength space, the dot product of the original signal vector with a PC vector is the magnitude of the original signal in the direction of the normalized component vector. More specifically, it is the magnitude of the normalized PC present in the original signal. This is analogous to breaking a vector in a three dimensional Cartesian space into its X, Y and Z components. The dot product of the three-dimensional vector with each axis vector, assuming each axis vector has a magnitude of 1, gives the magnitude of the three dimensional vector in each of the three directions. The dot product of the original signal and some other vector that is not perpendicular to the other three dimensions provides redundant data, since this magnitude is already contributed by two or more of the orthogonal axes.

Because the PCs are orthogonal, or perpendicular, to each other, the dot, or direct product of any PC with any other PC is zero. Physically, this means that the components do not interfere with each other. If data is altered to change the magnitude of one component in the original light signal, the other components remain unchanged. In the analogous Cartesian example, reduction of the X component of the three-dimensional vector does not affect the magnitudes of the Y and Z components. An example of PCA applied to fluorescence spectra is illustrated in FIG. 2.

PCA provides the fewest orthogonal components that can accurately describe the data carried by the light samples. Thus, in a mathematical sense, the PCs are components of the original light that do not interfere with each other and that represent the most compact description of the entire data carried by the light. Physically, each PC is a light signal that forms a part of the original light signal. Each has a shape over some wavelength range within the original wavelength range. Summing the PCs produces the original signal, provided each component has the proper magnitude. An example of reconstructing a spectrum from a reduced set of PCs is illustrated in FIG. 3.

The PCs comprise a compression of the data carried by the total light signal. In a physical sense, the shape and wavelength range of the PCs describe what data is in the total light signal while the magnitude of each component describes how much of that data is there. If several light samples contain the same types of data, but in differing amounts, then a single set of PCs may be used to exactly describe (except for noise) each light sample by applying appropriate magnitudes to the components.

Traditional multivariate calibration techniques like PCA, principle component regression (PCR), and partial least squares (PLS) extract spectral patterns related to pure component spectral variations and analyte concentrations or classifications in digitized data on a computer. A regression or loading vector can be calculated from a training set of mixture spectra to correlate analyte concentration or classification with the magnitude of a spectral pattern. Optical spectra and the associated spectral patterns can be viewed as vectors in hyperspace, where the true concentrations or classifications of an analyte are projections of the spectral vectors onto the spectral pattern vector.

Multivariate calibrations offer some distinct advantages in both analytical measurements as well as paradigm shifts in chemical analyses. Utilizing multiple variables in a calibration allows multiple components to be analyzed simultaneously. Highly correlated variables or neighboring wavelengths in spectroscopy offer increases in signal-to-noise ratios (SNR). Multiple calibration variables also increase the robustness of mathematical models by sampling a larger data region where interfering components may be readily observed.

Multivariate Optical Computing (MOC) combines the data collection and processing steps of a traditional multivariate chemical analysis in a single step. It offers an all-optical computing technology with little to no moving parts. MOC instrumentation is inexpensive to manufacture compared to scanning instrumentation in a compact, field-portable design. The speed benefit due to an optical regression can offer real-time measurements with relatively high SNR that realize the advantages of chemometrics in a simple instrument.

MOC may be separated into two categories defined by the method of applying a multivariate regression optically. The first focuses on the utilization of thin film interference filters called Multivariate Optical Elements (MOEs) to apply a dot product with an incident radiometric quantity yielding a single measured value related to a spectroscopically active chemical or physical property. An alternative optical regression method involves the modification of scanning or dispersive instrumentation with weighted integration intervals at each wavelength. This may be accomplished with an optical mask or by shuttering the detector or light source heterogeneously across the spectral range in intervals proportional to a calculated multivariate regression. Ultimately, an optical regression implements the complicated steps of a digital regression in a hardened apparatus where the chemometric advantages may be realized in a simple instrument that a non-expert can operate.

Interference filter pairs were introduced by Nelson et al. in 1998 as an optical regression technique. PCA was performed on Raman spectra from a polymer curing experiment to construct a multivariate regression. The positive portion of the regression vector was used as a template for designing an interference filter to express a similar dot product. The absolute value of the negative portion of the regression vector was also used as a template for an interference filter; an operation amplifier inverted the resulting signal. These filters were spatially homogeneous, and a photodiode sensed all wavelengths simultaneously. Spatial Light Modulators (SLM) and Digital Micro-mirror Devices (DMD) have also been utilized to apply spectroscopic regressions after the incident light has passed through a dispersive element. Such devices have allowed the real-time modification of the optical regression.

Compressive sensing and detection is the process in which a fully resolved waveform or image is reconstructed from a smaller set of sparse measurements. A sparse sample implies a waveform or image data set with coefficients close to or equal to zero. Compressive sensing utilizes the redundancy in information across the sampled signal similar to lossy compression algorithms utilized for digital data storage. A fully expanded data set may be created through the solution of an undetermined linear system, an equation where the compressive measurements collected are smaller than the size of the original waveform or image. To date, sensors employing MOEs have yielded a direct analytical concentration prediction or classification as opposed to reconstructing the original waveform or hyperspectral image.

Fluorescent marker detection devices, systems, and processes that do not suffer from one or more of the above drawbacks would be desirable in the art.

### BRIEF SUMMARY OF THE INVENTION

In an embodiment, an optical analysis system includes one or more optical filter mechanisms disposed to receive light from a light source and a detector mechanism configured for operative communication with the one or more optical filter mechanisms, the operative communication permitting measurement of properties of filtered light, filtered by the one or more optical filter mechanisms from the light received. The one or more optical filter mechanisms are configured so that the magnitude of the properties measured by the detector mechanism is proportional to information carried by the filtered light.

In another embodiment, an optical analysis system includes one or more optical filter mechanisms disposed to modulate light from a broadband light source and a detector mechanism configured for operative communication with the one or more optical filter mechanisms, the operative communication permitting measurement of properties of filtered light, filtered by the one or more optical filter mechanisms from the light modulated. The one or more optical filter mechanisms are configured so that the magnitude of the properties measured by the detector mechanism is proportional to information carried by the filtered light.

In another embodiment, an optical analysis process includes detecting information about an analyte from filtered light. The filtered light is from one or more optical filter mechanisms disposed to receive or modulate light from a light source. The detecting is by a detector mechanism configured for operative communication with the one or more optical filter mechanisms, the operative communication permitting measurement of properties of the filtered light, filtered by the one or more optical filter mechanisms from the light received or modulated. The one or more optical filter mechanisms are configured so that the magnitude of the properties measured by the detector mechanism is proportional to the information carried by the filtered light.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a linear algebraic diagram of Singular Value Decomposition (SVD) based on prior art where m and n correspond to rows and columns respectively, X is the spectroscopic data containing m samples measured by n wavelengths, U is the PC scores, S is the square root of the X^{T}X eigenvalues, and V^{T} is the transposed PC loading vectors. The shaded areas correspond to the transformation of a single spectrum within a larger data set based upon the first 3 Principal Components (PC1, PC2 and PC3).

FIG. 2 is an example fluorescence spectra reduced into independent scores in PC vector space by Principal Component Analysis (PCA); (A) Plot of fluorescence spectra; (B) Plot of spectroscopic variance explained (%) as a function of PC; (C) Plot of PC loading vectors 1, 2 and 3 for the fluorescence spectra; (D) Plot of PC scores of the fluorescence spectra on PC loading vectors 1, 2 and 3.

FIG. 3 is an example reconstruction or prediction of the sample 3 reflectance spectrum from FIG. 2 by only using the first three PCs describing 97% of the spectroscopic variance. The multiplied score (U_{PC}), square root of the eigenvalue (S_{PC}) and eigenvector (V^{T}_{PC}) are summed across each retained PC. A spectroscopic residual is illustrated to demonstrate the efficiency of spectroscopic reconstruction.

FIG. 4 is a schematic of an optical fluorescence emission analysis system, according to an aspect of the disclosure for point detection.

FIG. 5 is a schematic of an optical fluorescence excitation analysis system, according to an aspect of the disclosure for point detection.

FIG. 6 is a schematic of an optical fluorescence analysis system, according to an aspect of the disclosure for hyperspectral imaging.

FIG. 7 is a schematic of an optical fluorescence analysis system, according to an aspect of the disclosure for hyperspectral imaging.

FIG. 8 is a schematic of a compressive detection optical fluorescence excitation analysis system, according to an aspect of the disclosure for point detection.

FIG. 9 is an example optical system radiometric response, according to an aspect of the disclosure.

FIG. 10 is an example set of spectroscopically overlapping absorbance spectra (GFP & FITC) that can be resolved with an MOE analysis system, according to an aspect of the disclosure.

FIG. 11 is an example set of spectroscopically overlapping fluorescence emission spectra (GFP & FITC) that can be resolved with an MOE analysis system, according to an aspect of the disclosure.

FIG. 12 is an example set of MOE fluorescence emission results for, according to an aspect of the disclosure.

FIG. 13 is an example set of MOE fluorescence emission results for, according to an aspect of the disclosure.

FIG. 14 is an example optical system radiometric response, according to an aspect of the disclosure.

FIG. 15 is an example optical system radiometric response, according to an aspect of the disclosure.

FIG. 16 is an example set of spectroscopically overlapping absorbance spectra (GFP & FITC) that can be resolved with an MOE analysis system, according to an aspect of the disclosure.

FIG. 17 is an example set of spectroscopically overlapping emission spectra (GFP & FITC) that can be resolved with an MOE analysis system, according to an aspect of the disclosure.

FIG. 18 is an example snapshot array configuration using MOEs in a predefined kernel across a two dimensional detector surface using traditional optics.

FIG. 19 is an example hyperspectral image cube post pixel intensity rearrangement from a MOE-based snapshot imaging configuration.

FIG. 20 is an example snapshot array configuration using MOEs in a predefined kernel across a two dimensional detector surface using a microlens array.

FIG. 21 is an example hyperspectral image cube post pixel intensity rearrangement from a MOE-based snapshot imaging configuration.

FIG. 22 is an example set of spectroscopically overlapping absorbance spectra for a representative fluorescent assay panel using a 488-nm laser excitation.

FIG. 23 is an example set of compressed detections MOEs (or an MOE family) designed to discriminate the intensities of multiple emission from each other.

FIG. 24 is an example result of compressed detection MOEs (or an MOE family) designed to discriminate the intensities of multiple emission from each other.

FIG. 25 is an example set of spectroscopically overlapping fluorescence emission spectra for a representative fluorescent assay panel using a 488-nm laser excitation.

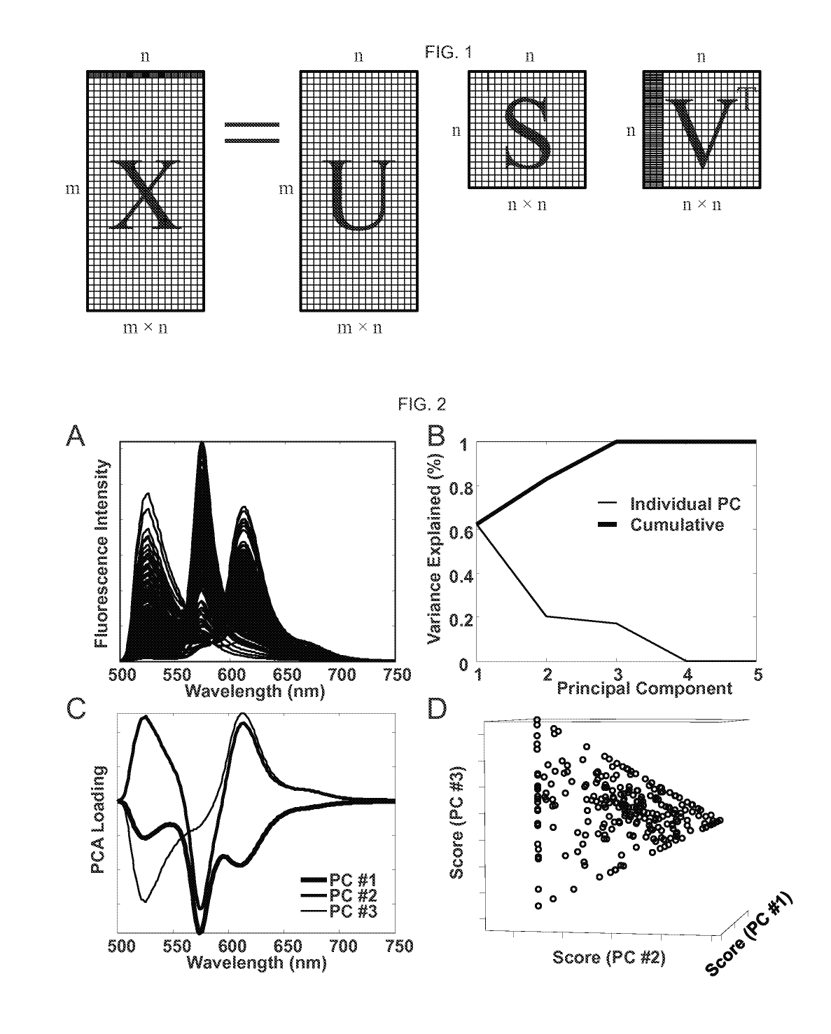

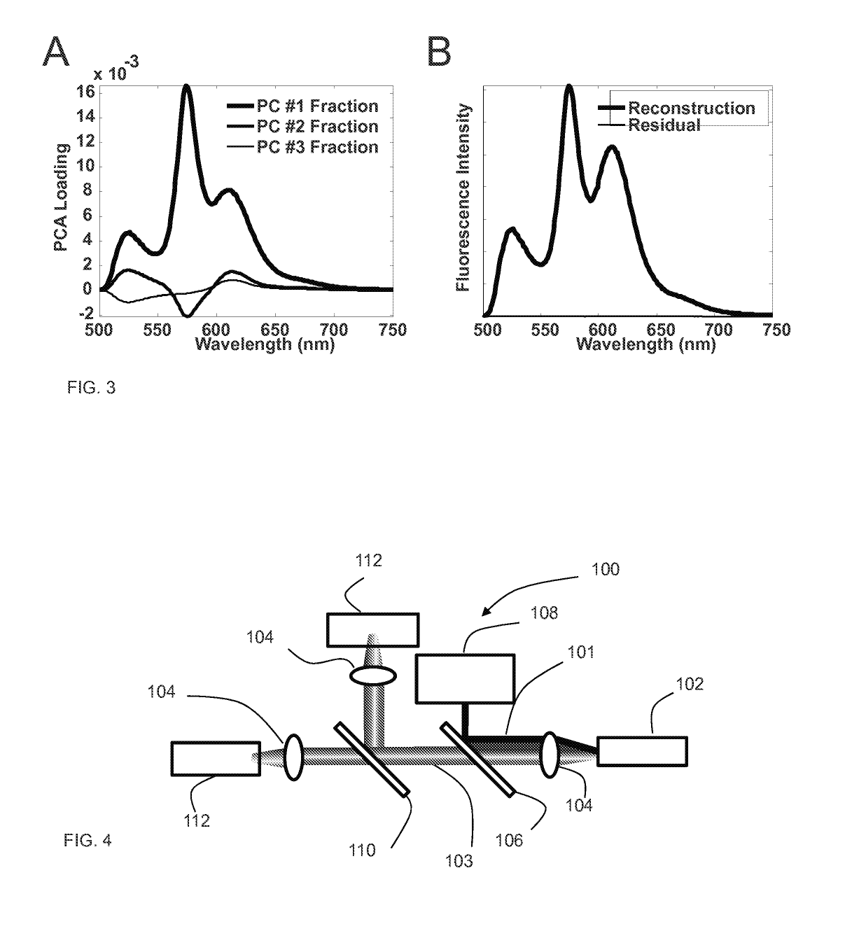

### DETAILED DESCRIPTION OF THE INVENTION

An optical analysis system and process are provided. The system and process provide features and benefits that will be apparent from the below detailed description, in comparison to the drawbacks identified above, and/or in comparison to similar concepts failing to disclose one or more of the features described herein.

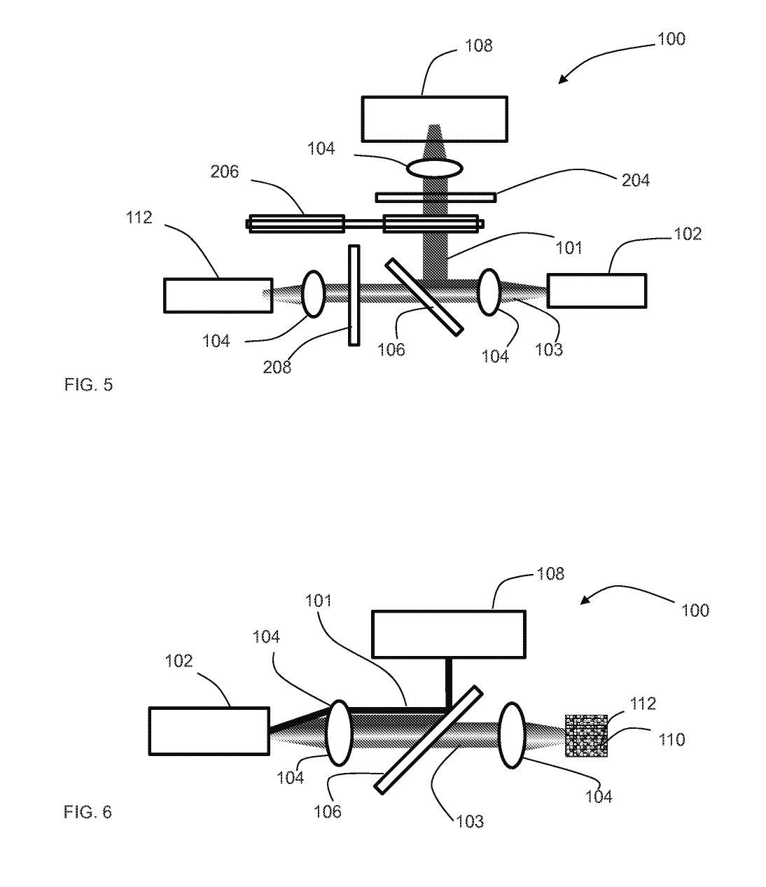

FIGS. 4-8 show an optical analysis system 100 for an optical analysis process. The system 100 includes one or more optical filter mechanisms, such as a multivariate optical element 110 (MOE) as in FIGS. 4 and 6-8 and/or a MOE fly wheel 206 as in FIG. 5. The system 100 further includes a detector mechanism 112 configured for operative communication with the one or more optical filter mechanisms, the operative communication permitting measurement of properties of filtered light, filtered by the one or more optical filter mechanisms from light received and/or modulated by the one or more optical filter mechanisms. The one or more optical filter mechanisms are configured so that the magnitude of the properties measured by the detector mechanism 112 is proportional to information carried by the filtered light.

FIGS. 4-8 show embodiments of an optical system 100 for analyzing a sample 102 though use of one or more arrangements of optics 104, a dichroic mirror 106, an energy source 108, one or more MOEs 110, and a detector 112, according to embodiments of a process according to the disclosure. The MOE 110 is a custom, wide band-pass optical interference filter that allows a simple filter-photometer instrument to achieve the sensitivity/specificity of a laboratory spectrometer. For example, the band-pass spans tens to hundreds of nanometers. In one embodiment, the system 100 is capable of being used in flow or imaging cytometry and/or detecting fluorescence moieties.

The MOE 110 is encoded with any suitable spectral patterns by using the optical transmission and reflection characteristics of an interference filter to detect/measure a complex chemical signature (for example, a target fluorochrome or class of fluorochromes) in the presence of a strongly interfering matrix (for example, secondary fluorochromes). The MOE 110 includes thin film interference filters that apply an optical scalar product with an incident radiometric quantity to produce a single measured value related to a spectroscopically-active chemical or physical property. To apply an optical scalar product, the MOE 110 induces a spectroscopic weighting or multiplication of the incident photons, while an addition of MOE-weighted photons occurs at the detector 112, for example, a broadband detector that is sensitive to more than a single color. Suitable detectors include, but are not limited to, silicon photodiode, photomultiplier tube, charge coupled device (CCD), complementary metal-oxide semiconductor (CMOS) array, other suitable detectors, and combinations thereof. The thin film interference filters are analyte specific (for example, with the analyte being a fluorescent moiety) and designed to replace the conventional spectroscopic subsystems that can be used for multivariate calibrations and prediction. A prediction of an analyte concentration or physical quality (y) is capable of being obtained without actually measuring the spectrum discretely. A dot product between a spectrum (x) at discrete wavelength channels (j) and a regression vector (b) are capable of being expressed as:

$$y = b \cdot x \\ y = {\sum }_{j = 1}^{J} {b}_{j} ( λ ) {x}_{j} ( λ ) \qquad ( Equation 2 )$$

Ultimately, an optical regression whereby an incident intensity of light is implicitly multiplied by the transmission or reflection properties of the interference filter implements the complicated steps of a digital regression in a hardened apparatus where the chemometric advantages is capable of being realized in a simple instrument that a non-expert can operate.

The evaluation of an MOE application begins with an assessment of technical feasibility. The system 100 parameters are then defined for the application. Suitable parameters are based upon the following: spectroscopic wavelength range of interest (for example, UV-vis, near infrared, etc.), point detection or imaging mode of operation (or angular field of view), environmental conditions of operation, performance metric (for example, sensitivity, specificity, concentration prediction error, misclassification rate, etc.), and/or other suitable considerations.

Next, a calibration and validation spectroscopic data set is constructed and evaluated for the intended application. In one embodiment, mixture fluorescence spectra of the fluorescence markers are generated based upon the specified system requirements. An assessment of the data via partial least squares (PLS) or other chemometric routine enables a confirmation as to whether the performance metrics of the system 100 parameters are capable of being achieved.

Including the MOE 110 in the system 100 permits a radiometric power measurement for a defined analyte, allowing the radiometric response of the system 100 to be identified and/or determined. In one embodiment, the effective spectral radiance measured by each fluorescence marker detection is generated by convolving the fluorescence spectrum of the fluorescence marker with the following optical properties: optical elements (for example, long pass filters, short pass filters, dichroic mirrors, etc.), radiometric response of the detector(s), optical transmission functions of the focusing/collection optics, and/or other suitable considerations. The spectroscopic and radiometric data are convolved in order to generate calibration and validation signatures for the process of designing the MOE 110. The calibration data set is capable of being employed to design the MOE 110 while the validation data is employed to challenge the design of the MOE 110.

Multivariate optical computing with interference filters is an analyte-specific technique. The design of the MOE 110 occurs through the consideration/characterization of a unique set of thin films that transmit and reflect weighted portions of the optically isolated spectral range to correlate spectral changes (for example, peak intensities or shifting in the calibration spectra) with changes in the known analyte physical or chemical properties. Designing a specific, wideband multi-layer optical filter entails the sampling of a multi-dimensional surface where each dimension corresponds to a layer thickness. In one embodiment, the values in each dimension are adjusted until a global minimum of the figure of merit is discovered. This iterative process is capable of seeking out any and all spectral deviations, even if one or more spectrally-interfering species are present. The resulting optical regression vector is mostly orthogonal to all interfering spectral components and mostly parallel with the analyte component.

The MOE 110 is fabricated by any suitable process, such as, with classic deposition equipment, techniques, and materials. In one embodiment, the MOE 110 includes fewer coating layers than traditional band-pass filters, resulting in less time in deposition chambers (for example, optical coating chambers, such as, reactive magnetron sputtering, ion beam deposition, etc.). Optical thin film manufacturers liken the resulting spectral profiles of the MOE 110 to arbitrary filter designs or gain-leveling filters. In one embodiment, dielectric materials are utilized for the thin film design/fabrication process of the MOE 110; however, there are multiple high/low index material pairs that are capable of being used for producing the MOE 110. For example, in one embodiment, a visible fluorescence filter uses Nb₂O₅ as a high index material and SiO₂ as a low index material. In other embodiments, materials having a similar index are used and/or materials having a similar difference in index are used.

Referring to FIG. 4, in one embodiment, the MOE 110 is configured for detection of two spectrally overlapping fluorescent markers, for example, highly spectrally overlapping fluorescent markers. Highly spectrally overlapping means that the emission spectra of two or more fluorescent markers occur around a common wavelength range (for example, as low as 10% overlap to as high as 100% overlap, about 20% overlap, about 40% overlap, about 60% overlap, about 80% overlap, or any suitable combination, sub-combination, range, or sub-range therein). In this embodiment, the system 100 includes the energy source 108 being a laser source. The laser source generates an energy beam 101 (such as a laser beam), which contacts the dichroic mirror 106, passes through a first arrangement of optics 104 and is directed to the sample 102. A fluorescence emission spectrum 103 is generated, passes through the dichroic mirror 106, contacts the MOE 110, and is split before passing through a second arrangement of optics 104 and two of the detectors 112.

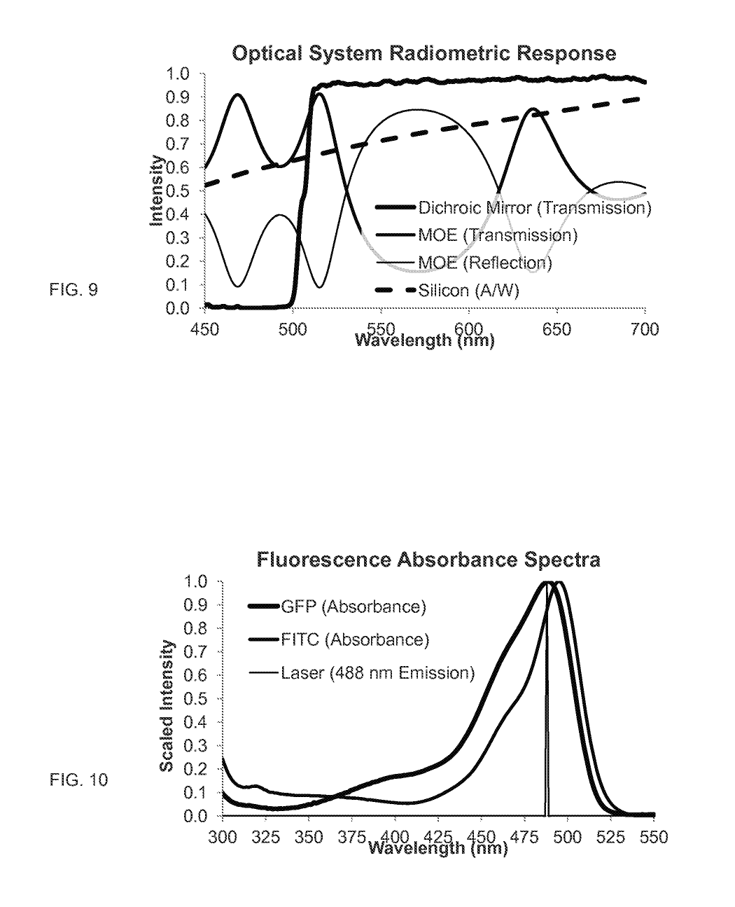

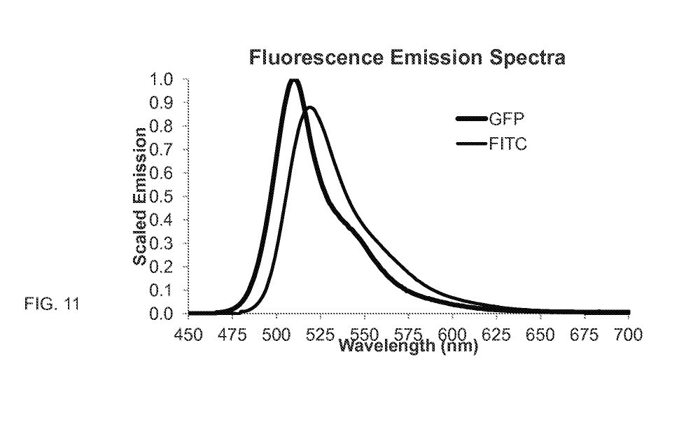

In general, FIGS. 9-13 show operational parameters and/or results capable of being used/achieved with the system 100 shown in FIG. 4. Based upon a laser excitation of the fluorescence markers near their respective absorbance maxima, the MOE 110 is designed to discriminate the emission signals of the fluorescence markers. By orienting the MOE 110 in a beamsplitter configuration (for example, between about 40° and about 50° or at about 45°), the transmission and reflection properties of the MOE 110 are realized for performing the target fluorescence marker concentration prediction. As compared to a traditional narrow band-pass photometer optical configuration, the configuration of the MOE 110 reduces the overall optical filter count by 2 filters.

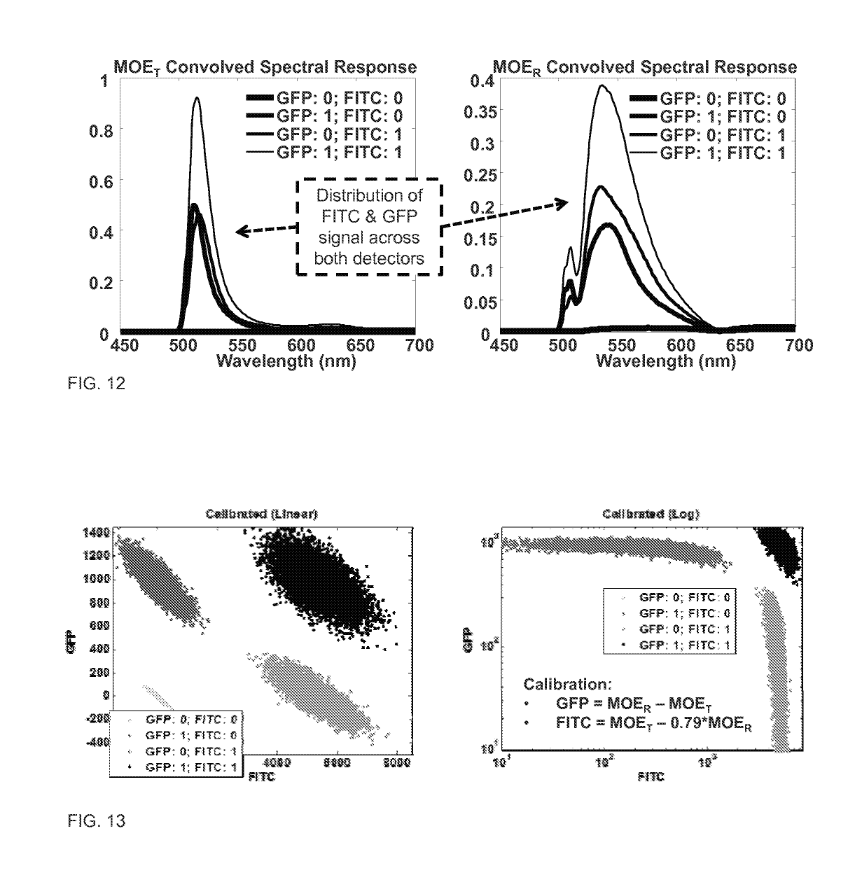

Referring to FIGS. 12-13, according to an embodiment utilizing the system 100 shown in FIG. 4, the detected signal for the fluorescence markers is spread across both the MOE transmission (MOE_{T}) and reflection (MOE_{R}) detectors. A final calibration for each fluorescence marker is constructed through the use of both the MOE transmission and reflection detections. In one embodiment, to overcome spectral interference from other fluorescence markers or environmental interferences, the MOEs 110 are designed with insensitivity to pH-induced color shift of fluorescence markers or other artifacts that may deteriorate a measurement and offer a utility for classes of fluorescence markers as opposed to just one.

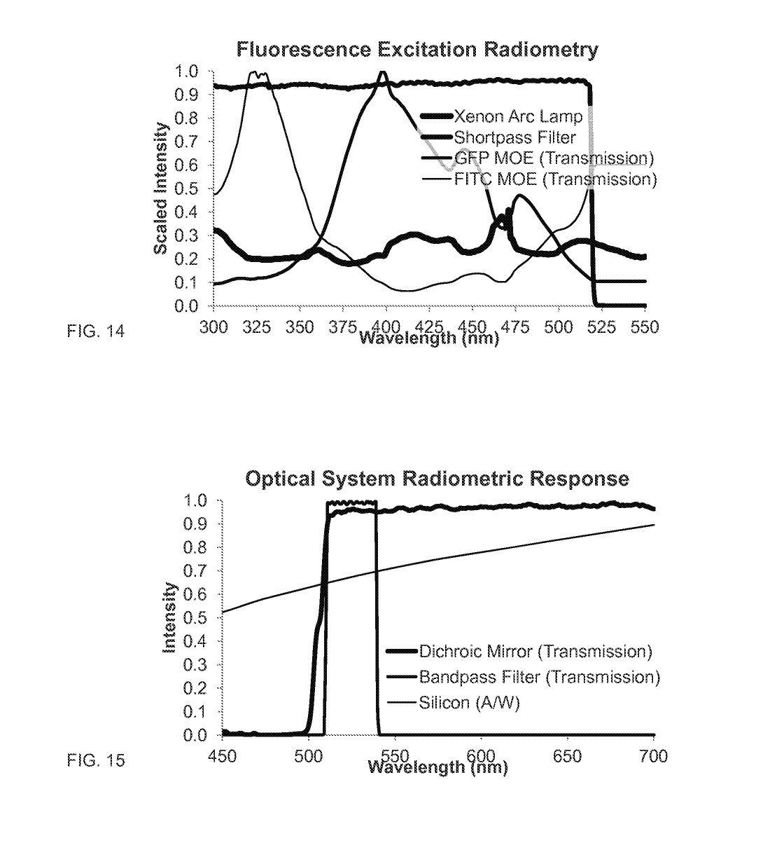

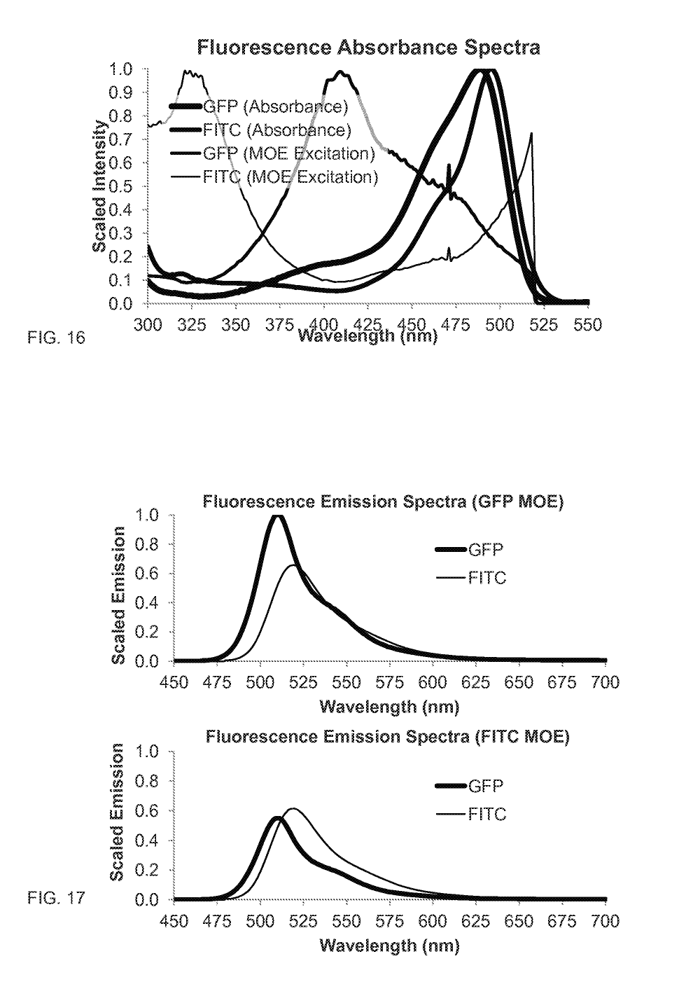

Referring to FIG. 5, in one embodiment, the system 100 includes the energy source 108 being a broadband light source. The energy source 108 generates the energy beam 101 (such as a light beam) that travels through a first arrangement of the optics 104, a shortpass filter 204, and an MOE filter wheel 206, prior to contacting the dichroic mirror 106. The energy beam 101 passes through a second arrangement of the optics 104 and contacts the sample 102. A fluorescence emission spectrum 103 is generated, passes through the second arrangement of the optics 104, passes through the dichroic mirror 106, a traditional band-pass filter 208, and passes through a third arrangement of the optics 104, prior to being detected by the detector 112. In general, FIGS. 14-17 show operational parameters and/or results capable of being used/achieved with the system 100 shown in FIG. 5. In this embodiment, a set of the MOEs 110 in the MOE filter wheel 206 modulate broadband excitation of the fluorescence markers across their respective absorbance bands allowing the traditional band-pass filter 208 to detect differences between the fluorescence marker intensities. Modulation of the excitation source is capable of being achieved through the use of (but not limited to) a filter or filter slider that is synchronized with the optical detection readout.

Referring to FIG. 6, in one embodiment, the system 100 includes the energy source 108 being a light source. The energy source 108 generates the energy beam 101 (such as a light beam) and contacts the dichroic mirror 106. The energy beam 101 passes through a first arrangement of the optics 104 and contacts the sample 102. A fluorescence emission spectrum 103 is generated, passes through the first arrangement of the optics 104, passes through the dichroic mirror 106, and passes through a second arrangement of the optics 104, prior to being detected by the detector 112, such as an array detector with the MOE(s) 110.

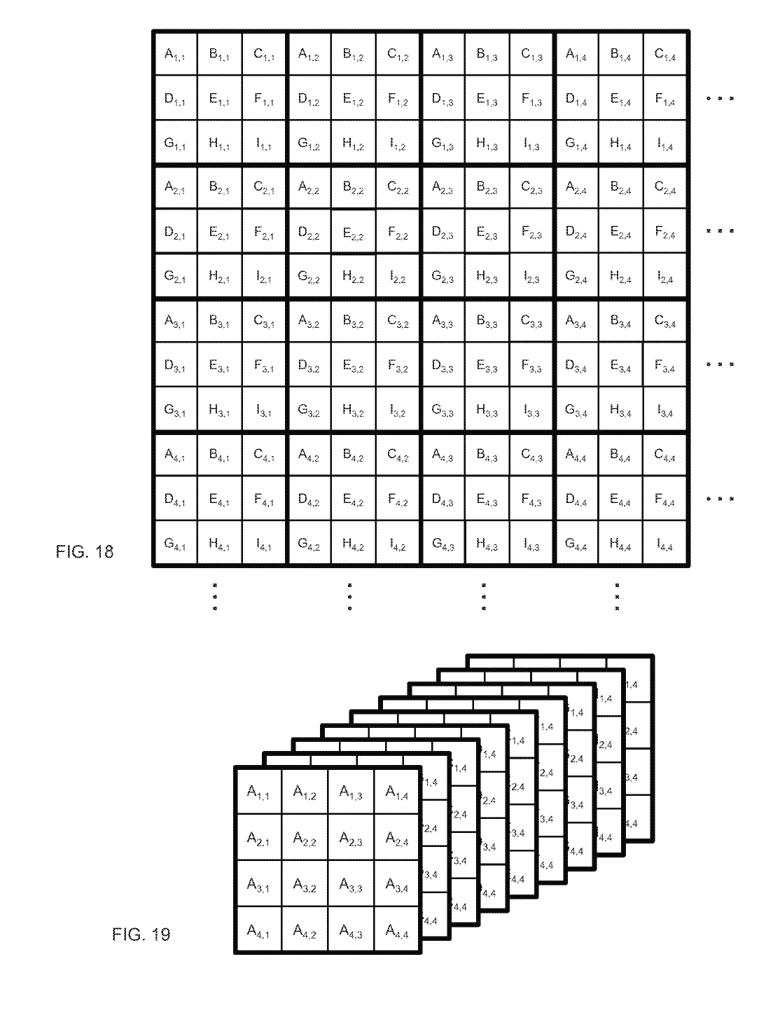

In the embodiment of the system 100 shown in FIG. 6, a UV excitation source 108 (such as a laser or broadband light source) is coupled with an array detector with the MOE(s) 110 in addition to neutral density filters of the MOE 110 for optical signal normalization. By exciting absorbance bands that are preferred to one of the fluorescence markers over others in the assay, the resulting fluorescence marker emission is capable of being better separated in intensity as compared to traditional narrow band excitation. FIG. 18 shows a snapshot imaging configuration in which the MOEs 110 are deposited directly to the detector 112, offering a compact method for generation of multiple images from the MOEs 110. Reconstructed MOE images, as shown in FIG. 19, are formed by an MOE kernel of defined size repeated across the array detector surface in which the MOEs 110 are designed for one or more fluorescence marker targets within the assay. In order to reconstruct the images from the MOEs 110 for further evaluation, the common components (or detector array pixels) from each of the MOE kernels are extracted via software and reassembled as images as a function of the MOE 110.

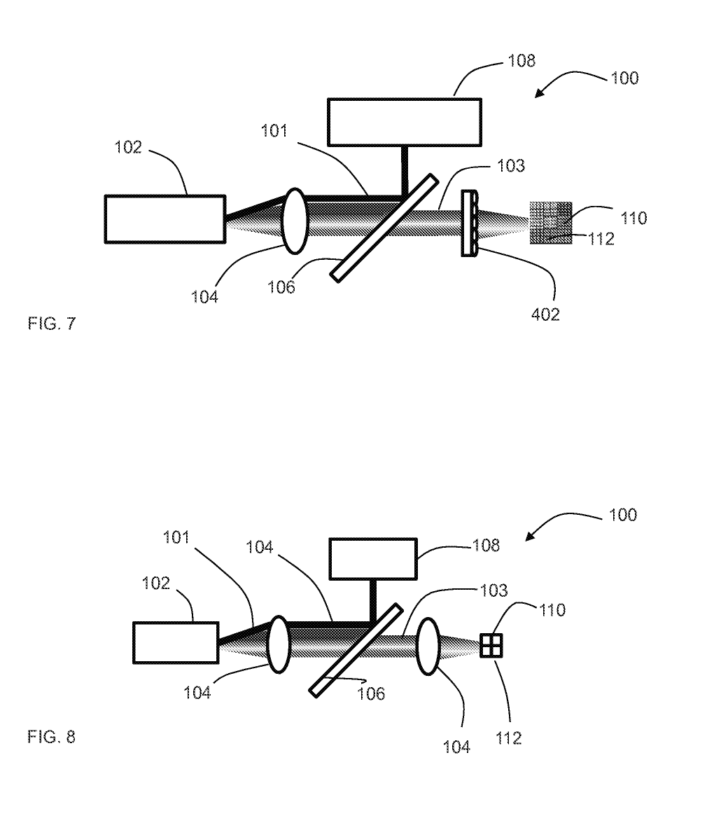

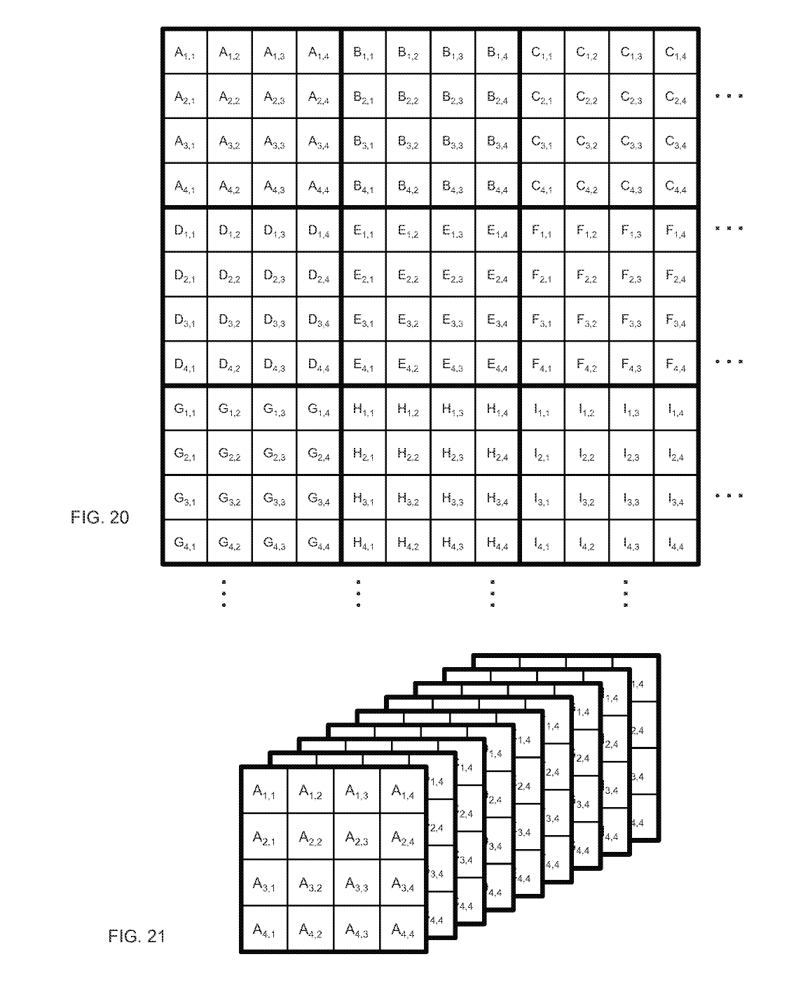

Referring to FIG. 7, in one embodiment, the system 100 includes the energy source 108 being a light source. The energy source 108 generates the energy beam 101 (such as a light beam) and contacts the dichroic mirror 106. The energy beam 101 passes through an arrangement of the optics 104 and contacts the sample 102. A fluorescence emission spectrum 103 is generated, passes through the first arrangement of the optics 104, passes through the dichroic mirror 106, and passes through a microlens array 402, prior to being detected by the detector 112, such as an array detector with the MOE(s) 110. FIG. 20 shows a suitable snapshot detection microarray capable of being used in the system 100. In one embodiment, amplitude measurements from a family of the MOEs 110 that model the largest/increased sources of spectroscopic variance (for example, principle component loading vectors) within the fluorescence spectral data set are exploited to reconstruct a spectroscopic prediction of the sample 102. Linear, multivariate models of complex data sets, such as fluorescence spectra, are capable of being developed through a transformation of the measured variables or spectral data onto orthogonal basis vectors. The orthogonal basis vectors, also known as principle components (PC), model statistically significant variation in the data as well as measurement noise. The data dimensionality is reduced to a set of basis vectors that model only spectral and measurement variation spanning the space of the data matrix without prior knowledge of chemical components.

In the embodiment of the system shown in FIG. 7, the microlens array 402 is employed as the focusing optical element in order to focus discrete sub-images, as are shown in FIG. 20, of the object onto the array of the detector 112, which is matched to the sub-image size of the MOEs 110 on the array surface of the detector 112. In order to reconstruct the images, as is shown in FIG. 21, from the MOE 110 for further evaluation, the common components (or detector array pixels) from each of the MOE kernels are extracted via software and reassembled as images as a function of the MOE 110. In one embodiment, amplitude measurements from a family of the MOEs 110 that model the largest/increased sources of spectroscopic variance (for example, principle component loading vectors) within the fluorescence spectral data set are exploited to reconstruct a spectroscopic prediction of the sample 102. Linear, multivariate models of complex data sets, such as fluorescence spectra, are capable of being developed through a transformation of the measured variables or spectral data onto orthogonal basis vectors. The orthogonal basis vectors, also known as principle components (PC), model statistically significant variation in the data as well as measurement noise. The data dimensionality is reduced to a set of basis vectors that model only spectral and measurement variation spanning the space of the data matrix without prior knowledge of chemical components.

Referring to FIG. 8, in one embodiment, the system 100 includes the energy source 108 being a laser source. The energy source 108 generates the energy beam 101 (such as a laser beam) and contacts the dichroic mirror 106. The energy beam 101 passes through a first arrangement of the optics 104 and contacts the sample 102. A fluorescence emission spectrum 103 is generated, passes through the first arrangement of the optics 104, passes through the dichroic mirror 106, and passes through a second arrangement of the optics 104, prior to being detected by the detector 112, such as an array detector with the MOE(s) 110.

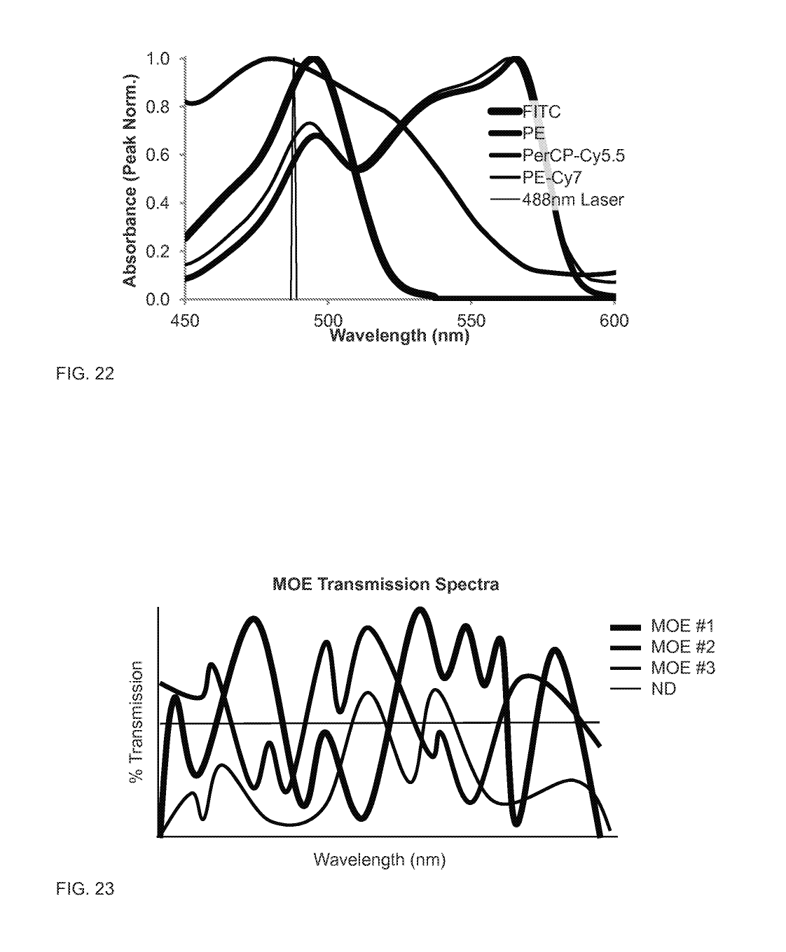

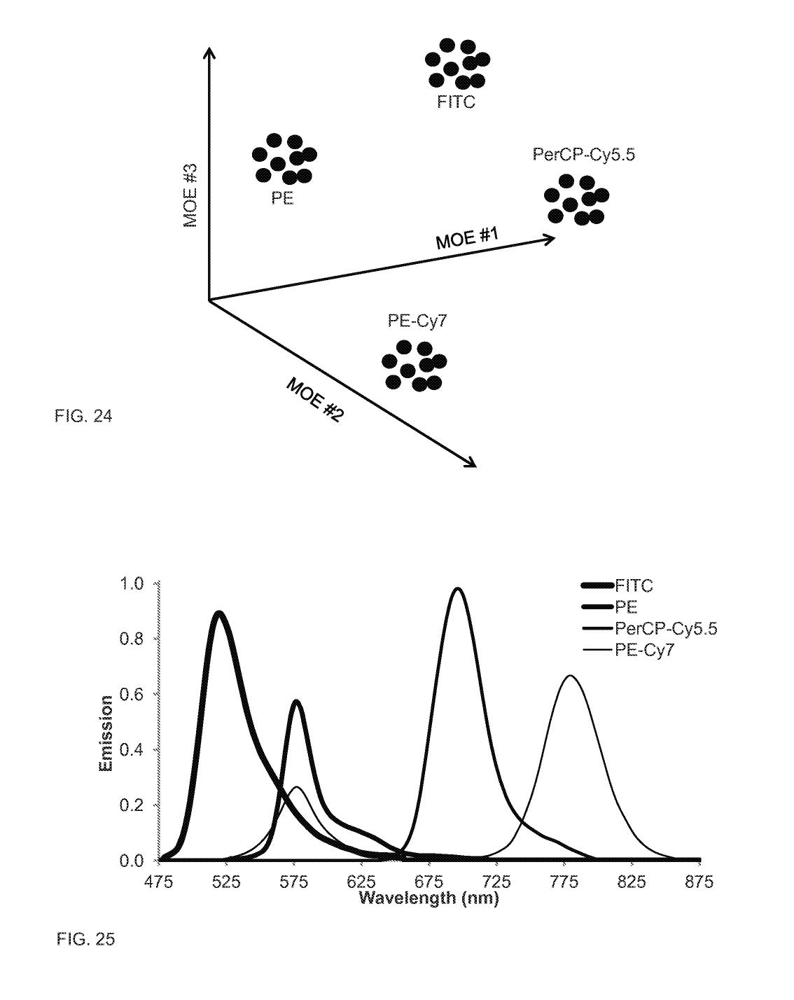

FIGS. 22-25 correspond to the embodiment of the system shown in FIG. 8, with spectroscopic compression being illustrated for a set of common fluorescence markers. As opposed to discrete narrow band-pass measurements for each fluorescence marker, a spectral variance, wide band-pass MOE family is employed to discriminate a target fluorescence marker from the other fluorescence markers. A design of a spectral variance MOE family includes forming a unique set of thin films across multiple optical filters of an optically isolated spectral range to perform one of the following, correlating an optical transmission function of the MOE with the principle component loading vectors of the top PCs, or correlating detector amplitude measurements with the principle component scores of the top PCs. A total number of spectral patterns (or PCs) to achieve a statistically significant amount of spectral variance explained is proportional to a total number of the MOEs 110 determined for achieving a compressive detection solution. The instrument radiometry and the spectral library provide the necessary radiometric response functions required for designing the compressive detection MOE family.

The design of a spectral variance (or compressed sensing) MOE family will occur through the optimization of a unique set of thin films across multiple optical filters of the optically isolated fluorescence spectral range to either: correlate the optical transmission function of the MOE with the principal component loading vectors of the top PCs describing a significant amount of the spectral variance; or correlate the detector amplitude measurements with the principle component scores of the top PCs describing a significant amount of the spectral variance. The total number of spectral patterns (or PCs) to describe a significant amount of spectra variance will be proportional to the total number of MOEs required to achieve a compressive detection solution. By measuring the amplitude of the MOE signal, a fully resolved optical spectrum may be reconstructed by a scaled, linear combination of the MOE transmission spectral vectors. A direct discrimination/classification of the target may also be achieved by using the MOE amplitudes as compressed measurements in a low-dimensional (spectroscopic) subspace.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims and all other patentable subject matter contained herein.

What is claimed is:

1. An optical analysis system, comprising:
one or more optical filter mechanisms disposed to receive light from a light source; and
a detector mechanism configured for operative communication with the one or more optical filter mechanisms, the operative communication permitting measurement of properties of filtered light, filtered by the one or more optical filter mechanisms from the light received;
wherein the one or more optical filter mechanisms are configured so that the magnitude of the properties measured by the detector mechanism is proportional to information carried by the filtered light.

2. The system according to claim 1, wherein the one or more optical filter mechanisms comprise at least one multivariate optical element.

3. The system according to claim 1, wherein the one or more optical filter mechanisms comprise at least one neutral density filter.

4. The system according to claim 1, wherein the one or more optical filter mechanisms comprise at least one band pass filter.

5. The system according to claim 1, wherein the light source employed to generate light from the sample is selected from the group consisting of a broadband illumination light source, a light emitting diode (LED), laser, and combinations thereof.

6. The system according to claim 1, wherein the detector mechanism includes a point detector.

7. The system according to claim 6, wherein the point detector is configured for a number of unique optical filter measurements usable to compute an estimate of a value of a wavelength spectrum, wherein the number is less than the value.

8. The system according to claim 1, wherein the information carried by the filtered light relates to an analyte, the analyte being a fluorescent moiety.

9. The system according to claim 1, wherein the system is capable of use in flow or imaging cytometry.

10. A process, comprising executing the operative communication in the system of claim 1.

11. A process, comprising detecting the information by using the system of claim 1.

12. An optical analysis system, comprising:
one or more optical filter mechanisms disposed to modulate light from a broadband light source; and
a detector mechanism configured for operative communication with the one or more optical filter mechanisms, the operative communication permitting measurement of properties of filtered light, filtered by the one or more optical filter mechanisms from the light modulated;
wherein the one or more optical filter mechanisms are configured so that the magnitude of the properties measured by the detector mechanism is proportional to information carried by the filtered light.

13. The system according to claim 12, wherein the one or more optical filter mechanisms comprise at least one multivariate optical element.

14. The system according to claim 12, wherein the one or more optical filter mechanisms comprise at least one neutral density filter.

15. The system according to claim 12, wherein the one or more optical filter mechanisms comprise at least one band pass filter.

16. The system according to claim 12, wherein the detector mechanism includes a point detector.

17. The system according to claim 12, wherein the point detector is configured for a number of unique optical filter measurements usable to compute an estimate of a value of a wavelength spectrum, wherein the number is less the value.

18. The system according to claim 12, wherein the information carried by the filtered light relates to an analyte, the analyte being a fluorescent moiety.

19. The system according to claim 12, wherein the system is capable of use in flow or imaging cytometry.

20. An optical analysis process, comprising:
detecting information about an analyte from filtered light;
wherein the filtered light is from one or more optical filter mechanisms disposed to receive or modulate light from a light source; and
wherein the detecting is by a detector mechanism configured for operative communication with the one or more optical filter mechanisms, the operative communication permitting measurement of properties of the filtered light, filtered by the one or more optical filter mechanisms from the light received or modulated;
wherein the one or more optical filter mechanisms are configured so that the magnitude of the properties measured by the detector mechanism is proportional to the information carried by the filtered light.
